(19) United States
(12) Patent Application Publication
(10) Pub. No.: US 2024/0380468 A1
(43) Pub. Date: Nov. 14, 2024

(54) FLEXIBLE ANTENNA CONFIGURATIONS

(71) Applicant: CommScope Technologies LLC, Claremont, NC (US)

(72) Inventors: Arthur J. Barabell, Sudbury, MA (US); Ehsan Daeipour, Southborough, MA (US); Stuart D. Sandberg, Acton, MA (US); Balaji B Raghothaman, Chester Springs, PA (US)

(73) Assignee: CommScope Technologies LLC, Claremont, NC (US)

(21) Appl. No.: 18/692,715

(22) PCT Filed: Sep. 15, 2022
(86) PCT No.: PCT/US2022/043668

§ 371 Date: Mar. 15, 2024

Related U.S. Application Data
(60) Provisional application No. 63/291,200, filed on Dec. 17, 2021.
(60) Provisional application No. 63/291,204, filed on Dec. 17, 2021.
(60) Provisional application No. 63/291,196, filed on Dec. 17, 2021.
(60) Provisional application No. 63/244,593, filed on Sep. 15, 2021.

(51) Int. Cl. H04B 7/06; H04B 7/0426; H04B 7/0456; H04B 7/0495; H04B 7/08; H04L 5/00; H04W 72/1273; H04W 74/0833

(52) U.S. Cl. CPC H04B 7/0691; H04B 7/0456; H04B 7/0495; H04B 7/0874; H04L 5/0048; H04W 74/0833; H04B 7/043; H04W 72/1273

(57) ABSTRACT

Systems and methods for flexible antenna configurations and beamforming are provided. In one example, a system includes: at least one controller configured to implement at least some functions for one or more layers of a wireless interface used to communicate with UEs; remote unit(s) communicatively coupled to the at least one controller; and antenna elements communicatively coupled to the remote unit(s), each respective antenna element oriented in a respective direction different than other antenna elements. The at least one controller is configured to: determine a location of a UE in a cell of the system and/or channels between the antenna elements and the UE; select antenna element(s) for use in transmitting downlink signals to the UE based on the location of the UE and/or the channels between the antenna elements and the UE; and transmit downlink signals to the UE via the selected antenna element(s) in a first time period.

### CROSS-REFERENCE TO RELATED APPLICATIONS

This application claims benefit of U.S. Provisional Patent Application No. 63/244,593 filed on Sep. 15, 2021, titled “FLEXIBLE ANTENNA CONFIGURATIONS,” U.S. Provisional Patent Application No. 63/291,196 filed on Dec. 17, 2021, titled “FLEXIBLE ANTENNA CONFIGURATIONS,” U.S. Provisional Patent Application No. 63/291,200 filed Dec. 17, 2021, titled “SMARTREUSE BEAMFORMING,” and U.S. Provisional Patent Application No. 63/291,204 filed on Dec. 17, 2021, titled “SMARTREUSE BEAMFORMING TRADING COVERAGE AND CAPACITY,” the contents of all of which are incorporated herein in their entirety.

### BACKGROUND

This disclosure relates to wireless communication systems.

### SUMMARY

In one example, a system includes at least one controller configured to implement at least some functions for one or more layers of a wireless interface used to communicate with user equipment. The system further includes one or more remote units communicatively coupled to the at least one controller. The system further includes a plurality of antenna elements communicatively coupled to the one or more remote units, and each respective antenna element of the plurality of antenna elements is oriented in a respective direction different than other antenna elements of the plurality of antenna elements. The at least one controller is configured to determine a location of a first user equipment in a cell of the system and/or channels between the plurality of antenna elements and the first user equipment. The at least one controller is further configured to select one or more first antenna elements of the plurality of antenna elements for use in transmitting downlink signals to the first user equipment based on the location of the first user equipment and/or the channels between the plurality of antenna elements and the first user equipment. The at least one controller is further configured to transmit downlink signals to the first user equipment via the one or more first antenna elements of the plurality of antenna elements in a first time period.

In another example, a system includes at least one controller configured to implement at least some functions for one or more layers of a wireless interface used to communicate with user equipment. The system further includes a plurality of remote unit digital circuits communicatively coupled to the at least one controller. The system further includes a plurality of antenna elements communicatively coupled to the plurality of remote unit digital circuits and configured to radiate radio frequency signals to the user equipment. The system further includes an antenna connection subsystem configured to selectively, communicatively couple the plurality of remote unit digital circuits to the plurality of antenna elements. Each of the antenna elements is configured to be coupled to a remote unit digital circuit of the plurality of remote unit digital circuits via the antenna connection subsystem for a particular communication direction.

In another example, a system includes at least one controller configured to implement at least some functions for one or more layers of a wireless interface used to communicate with user equipment. The system further includes one or more radio units communicatively coupled to the at least one controller. The system further includes a plurality of antenna elements communicatively coupled to the one or more radio units. The at least one controller is configured to determine a location of a first user equipment in a first sector of the system. The at least one controller is further configured to select a first antenna beam state of a plurality of antenna beam states for the first sector to use in transmitting downlink signals to the first user equipment based on the location of the first user equipment. Each respective antenna beam state of the plurality of antenna beam states for the first sector includes a respective complex-valued tapered weighting vector to reduce leakage in other sectors adjacent to the first sector. The at least one controller is further configured to transmit downlink signals to the first user equipment using the first antenna beam state of the plurality of antenna beam states for the first sector during a first time period.

In another example, a system includes at least one controller configured to implement at least some functions for one or more layers of a wireless interface used to communicate with user equipment. The system further includes one or more radio units communicatively coupled to the at least one controller. The system further includes a plurality of antenna elements communicatively coupled to the one or more radio units. The at least one controller is configured to transmit downlink signals to a first user equipment in a first zone of a first sector of the system using a first antenna beam state of a plurality of antenna beam states for the first sector during a first time period. The at least one controller is further configured to switch from the first antenna beam state of the plurality of antenna beam states for the first sector to a second antenna beam state of the plurality of antenna beam states for the first sector during a second time period that follows the first time period. The at least one controller is further configured to transmit downlink signals to a second user equipment in a second zone of the first sector of the system using the second antenna beam state of the plurality of antenna beam states for the first sector during the second time period.

In another example, a method includes transmitting downlink signals to a first user equipment in a first zone of a first sector of a system using a first antenna beam state of the plurality of antenna beam states for the first sector during a first time period. The system includes at least one controller configured to implement at least some functions for one or more layers of a wireless interface used to communicate with user equipment, one or more radio units communicatively coupled to the at least one controller, and a plurality of antenna elements communicatively coupled to the one or more radio units. The method further includes switching from the first antenna beam state of a plurality of antenna beam states for the first sector to a second antenna beam state of the plurality of antenna beam states for the first sector during a second time period that follows the first time period. The method further includes transmitting downlink signals to a second user equipment in a second zone of the first sector of the system using the second antenna beam state of the plurality of antenna beam states for the first sector during the second time period, wherein the second zone is different than the first zone.

In another example, a system includes at least one controller configured to implement at least some functions for one or more layers of a wireless interface used to communicate with user equipment. The system further includes one or more radio units communicatively coupled to the at least one controller. The system further includes a plurality of antenna elements communicatively coupled to the one or more radio units. The at least one controller is configured to classify a first user equipment as being in a first state or in a second state based on one or more first signal reception parameters. The at least one controller is further configured to, in response to classifying the first user equipment as being in the first state, transmit downlink signals to the first user equipment via a first subset of antenna elements of the plurality of antenna elements in a first time period using a first type of antenna beam. The at least one controller is further configured to, in response to classifying the first user equipment as being in the second state, transmit downlink signals to the first user equipment via a second subset of antenna elements of the plurality of antenna elements in the first time period using a second type of antenna beam.

In another example, a method includes classifying a first user equipment in a sector of a system as being in a first state or a second state based on one or more first signal reception parameters. The system includes at least one controller configured to implement at least some functions for one or more layers of a wireless interface used to communicate with user equipment. The system further includes one or more radio units communicatively coupled to the at least one controller and a plurality of antenna elements communicatively coupled to the one or more radio units. The method further includes, in response to classifying the first user equipment as being in the first state, transmitting downlink signals to the first user equipment via a first subset of antenna elements of the plurality of antenna elements in a first time period using a first type of antenna beam. The method further includes, in response to classifying the first user equipment as being in the second state, transmitting downlink signals to the first user equipment via a second subset of antenna elements of the plurality of antenna elements in the first time period using a second type of antenna beam.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a diagram of an example radio access network;

FIG. 2 is a diagram of an example remote unit;

FIG. 3 is a diagram of a sectorized antenna system;

FIG. 4 is a diagram of an example system with a flexible antenna configuration;

FIG. 5 is a diagram of an example system with a flexible antenna configuration;

FIG. 6 is a diagram of an example antenna connection subsystem;

FIGS. 7A-7F illustrate example configurations of a system with a flexible antenna configuration;

FIG. 8 is a diagram of an example system utilizing beamforming; and

FIG. 9 is a diagram of an example system utilizing beam switching.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be used and that logical, mechanical, and electrical changes may be made. The following detailed description is, therefore, not to be taken in a limiting sense.

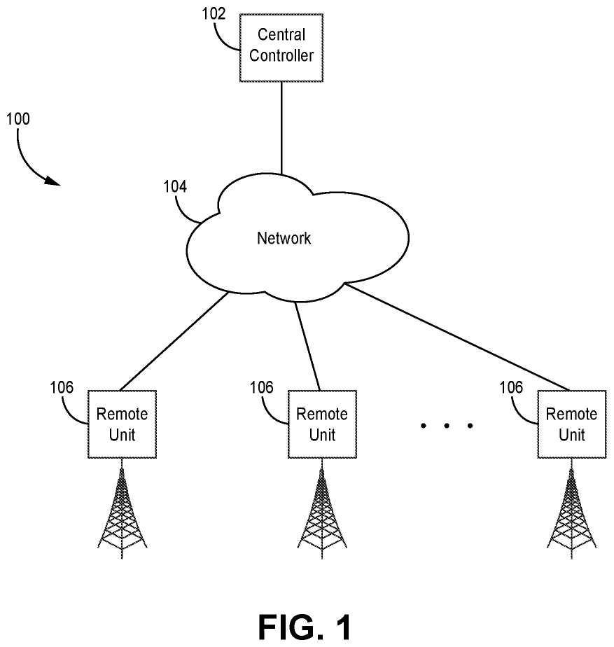

FIG. 1 is a diagram illustrating a typical disaggregated radio access network 100. In general, a disaggregated radio access network can be partitioned into different entities, each of which can be implemented in different ways. In the particular example shown in FIG. 1, a disaggregated radio access network 100 includes a central controller 102 and one or more remote units 106 (also referred to here as “RUs,” “radio points,” or “RPs”).

The central controller 102 typically performs the Layer 2 and Layer 3 functions of the wireless air interface and may perform some of the Layer 1 functions. In 5G network examples, the central controller 102 is partitioned into one or more central units (CUs) and one or more distributed units (DUs). In some such examples, each CU is further partitioned into a central unit control-plane (CU-CP) and one or more central unit user-planes (CU-UPs) dealing with the gNB Packet Data Convergence Protocol (PDCP) and higher layers of functions of the respective control and user planes of the radio access network 100 in order to allow independent scaling and placement of these functions. Each DU is configured to implement the upper part of the physical layer through the radio link control layer of both the control-plane and user-plane of the radio access network 100.

In the example shown in FIG. 1, the radio access network 100 includes multiple remote units 106 in order to provide wireless service to various items of user equipment (UEs). The multiple remote units 106 are typically located remotely from each other (that is, the multiple remote units 106 are not co-located), but one or more of the remote units 106 can be co-located in some implementations. The remote units 106 are communicatively coupled to the central controller 102 over a network 104. In this example, each RU 106 is configured to implement the radio frequency (RF) interface and lower physical layer control-plane and user-plane functions of the radio access network 100.

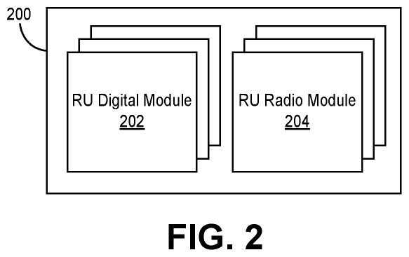

FIG. 2 is a diagram of an example remote unit 106. In the example shown in FIG. 2, the remote unit 106 includes a digital circuit 202 and a radio circuit 204. The digital circuit 202 is configured to perform transport layer processing. In some examples, the digital circuit 202 is further configured to perform at least a portion of the air interface physical layer processing, which is often referred to as “Lower PHY” or “Lower L1” processing. The radio circuit 204 is typically configured to perform digital-to-analog conversion for transmit signals and analog-to-digital conversion for receive signals. In some examples, the digital circuit 202 is configured to perform digital-to-analog conversion for transmit signals and analog-to-digital conversion for receive signals. The radio circuit 204 includes amplifiers for transmit signals and amplifiers for receive signals. In some examples, the radio circuit 204 is configured to perform modulation of a baseband signal to the desired carrier frequency. In some examples, the radio circuit 204 is attached to an antenna or to a distributed antenna system (DAS).

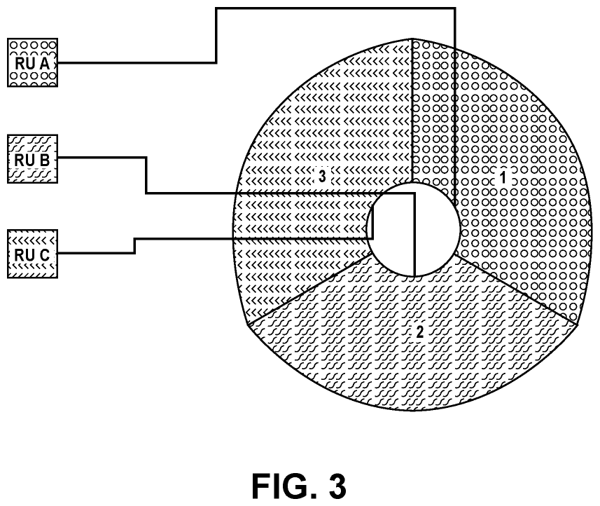

In an outdoor setting, sectorized antennas are often utilized for a radio access network. Typically, for such implementations, the 360 degrees of view are divided into equal sectors and each sector is driven by its own remote unit (as shown in FIG. 3). This configuration has several limitations. First, the distribution of capacity is inherently uniform, so a non-uniform distribution of users around the system can result in users being underserved even though there is an excess of overall capacity in the system. Further, precise alignment of the sector positions of the antenna sectors for these systems is likely required for RF planning purposes, which makes installation more complicated. Furthermore, it is difficult to accommodate any modifications desired for the RF network after installation due to the fixed position of the sectors.

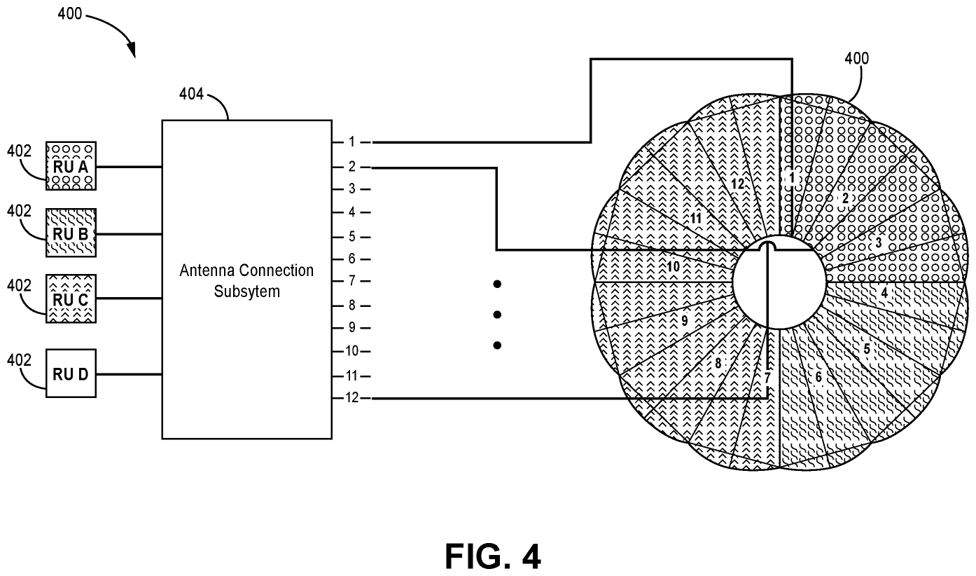

FIG. 4 is a diagram illustrating a portion of an example radio access network 400 in which the flexible antenna sectorization and beamforming techniques described herein can be implemented. In the particular example shown in FIG. 4, the radio access network 400 includes remote units 402, an antenna connection subsystem 404, and antenna segments 406. In the example shown in FIG. 4, the radio access network 400 includes four remote units 402 and twelve antenna segments 406. However, it should be understood that the particular configuration shown in FIG. 4 is only one example and a different number of remote units (including one) and/or an antenna with a different number of segments (two or more) can be used. Moreover, although the embodiments described herein are primarily described as being implemented for use to provide 5G NR service, it is to be understood the techniques described here can be used with other wireless interfaces (for example, fourth generation (4G) Long-Term Evolution (LTE) service) and references to “gNB” can be replaced with the more general term “base station” or “base station entity” and/or a term particular to the alternative wireless interfaces (for example, “enhanced NodeB” or “eNB”). Furthermore, it is also to be understood that 5G NR embodiments can be used in both standalone and non-standalone modes (or other modes developed in the future) and the following description is not intended to be limited to any particular mode. Also, unless explicitly indicated to the contrary, references to “layers” or a “layer” (for example, Layer 1, Layer 2, Layer 3, the Physical Layer, the MAC Layer, etc.) set forth herein refer to layers of the wireless interface (for example, 5G NR or 4G LTE) used for wireless communication between a base station and user equipment).

In the example shown in FIG. 4, each remote unit 402 is communicatively coupled to the antenna connection subsystem 404. In the example shown in FIG. 4, the remote units 402 include both a digital circuit and a radio circuit as discussed above with respect to FIG. 2. Thus, the remote units 402 in FIG. 4 are configured to output analog signals for transmission to the antenna connection subsystem 404 in the downlink and to receive analog signals for reception from the antenna connection subsystem 404 in the uplink.

In some examples, the remote units 402 are configured to comply with one or more Open Radio Access Network (O-RAN) standards and include an O-RAN compliant interface. In other examples, the remote units use a proprietary interface.

In some examples, each remote unit 402 is communicatively coupled (“homed”) to a dedicated, corresponding DU, where each DU implements a distinct cell having a different Physical Cell Identifier (PCI). In other examples, each remote unit 402 is communicatively coupled (“homed”) to the same DU and thus part of the same cell with a single PCI. In other examples, one or more of the remote units 402 are communicatively coupled to a dedicated, corresponding DU and at least two of the remote units 402 are communicatively coupled to the same DU.

While the remote units can be implemented as physically distinct components, it should be understood that the remote units do not have to be physically distinct. For example, the remote units 402 could be “virtual” remote units as part of a multi-operator, multi-carrier remote unit. Similarly, while the DUs can be implemented as physically distinct components, it should be understood that the DUs could also be virtual DUs.

The RUs, DUs, and CU can be co-located or separated in accordance with the different split options defined in 3rd Generation Partnership Project (3GPP) or O-RAN specifications or based on a proprietary split of these components. In some examples described herein, the DU and the RU are in the same physical unit and the CU is separate from the DU and RU, which is referred to as the Split Option 2 in 3GPP and O-RAN specifications.

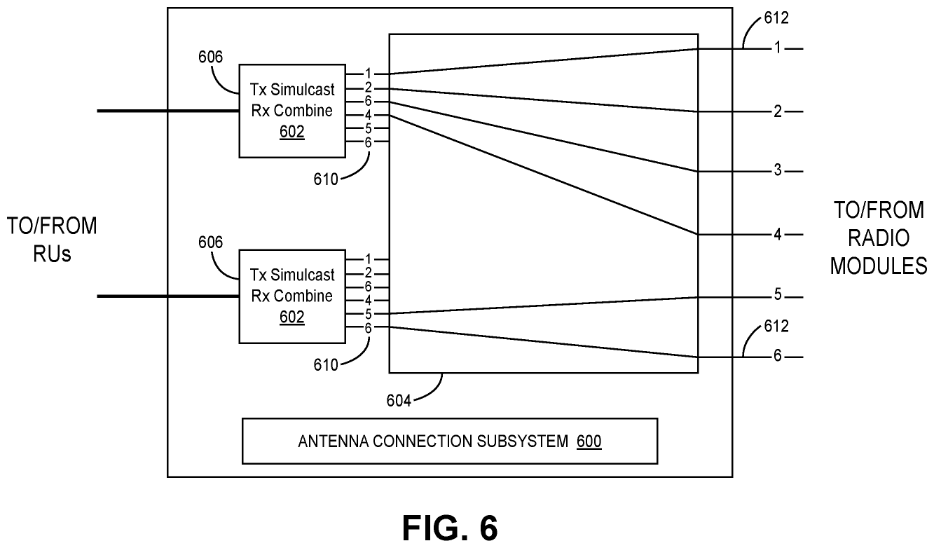

The antenna connection subsystem 404 is communicatively coupled to the antenna segments 406. The antenna connection subsystem 404 is configured to connect the antenna segments 406 with different remote units 402. The antenna connection subsystem 404 shown in FIG. 4 includes similar components to those shown in and described with respect to FIG. 6 below.

In some examples, the antenna connection subsystem 404 is configured to connect each antenna segment 406 to one and only one remote unit 402 in a particular communication direction, but multiple antenna segments 406 can be connected to the same remote unit 402 at one time. When multiple antenna segments 406 are connected to the same remote unit 402, the multiple antenna segments 406 transmit the same signal (simulcast) in the downlink and the contribution from each of the multiple antenna segments 406 is combined in the uplink. When multiple (for example, K) adjacent antenna segments 406 are connected to the same remote unit, the effect is to produce a combined antenna segment 406 covering ((360*K)/N) degrees of view, where N is the total number of antenna segments 406. In the example shown in FIG. 4, each antenna segment 406 covers 30 degrees.

In some configurations, the antenna segments 406 are deployed together, for example, mounted at the top of a tower or mast in a circular array or mounted on a wall in a partial (for example, 180 degree) circular array. In such a configuration, the RUs 402 need not be co-located with the antenna segments 406 and, for example, can be co-located together (for example, at the base of the tower or mast structure) and, possibly, co-located with their serving DUs. In some configurations, the antenna segments 406 are physically separated. Other configurations can be used.

It should be understood that FIG. 4 is a logical depiction of the components of the radio access network 400 and different components can be combined on the same hardware. For example, the remote units 402 and the antenna connection subsystem 404 can be combined on the same hardware.

The examples described above with respect to FIG. 4 can have a few challenges related to using analog signals and the antenna connection subsystem 404. Since the remote units 402 output analog signals in the downlink to the antenna connection subsystem 404, the power levels received by the antenna connection subsystem 404, in particular, can be significant. The examples described above with respect to FIG. 4 also can have higher insertion loss and passive intermodulation distortion in the antenna connection subsystem 404.

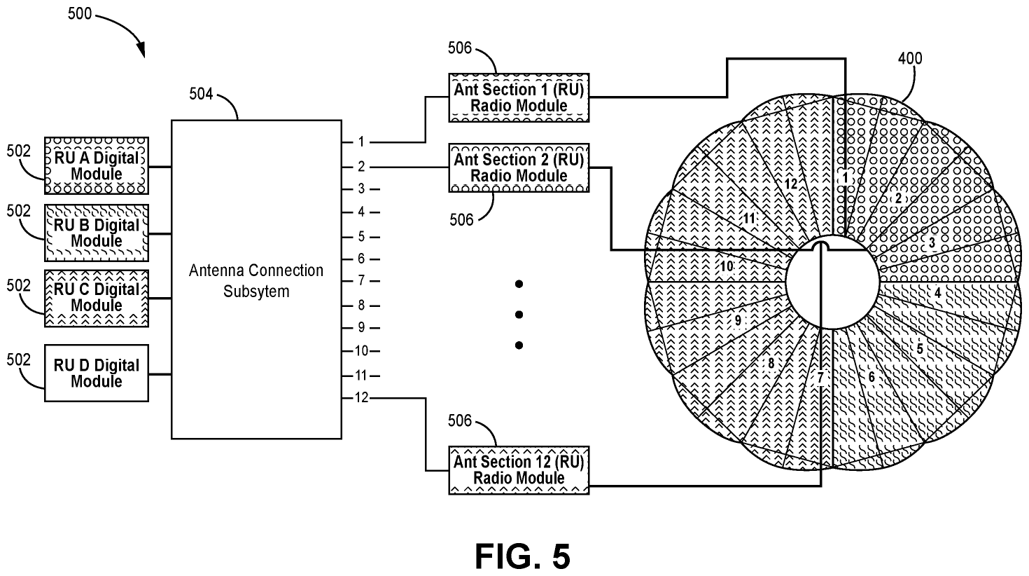

To reduce some of the challenges associated with using analog signals with the antenna connection subsystem, an alternative approach where the functionality of the remote units is split can be implemented. FIG. 5 is a diagram illustrating a portion of an alternative radio access network 500 in which the techniques described herein can be implemented. In the particular example shown in FIG. 5, the radio access network 500 includes RU digital circuits 502, an antenna connection subsystem 504, antenna section radio circuits 506 (also referred to as “RU radio circuits” or “RU radio modules”), and multiple antenna segments 508.

In the example shown in FIG. 5, the radio access network 500 includes four RU digital circuits 502, twelve antenna section radio circuits 506, and twelve antenna segments 508. However, it should be understood that the particular configuration shown in FIG. 5 is only one example and a different number of RU digital circuits (including one), antenna section radio circuits (two or more) and/or a different number of antenna segments (two or more) can be used.

In the example shown in FIG. 5, each RU digital circuit 502 is communicatively coupled to the antenna connection subsystem 504. The RU digital circuits 502 include similar component(s) to those discussed above with respect to the digital circuit 202 in FIG. 2. Thus, the RU digital circuits 502 in FIG. 5 are configured to output digital signals for transmission to the antenna connection subsystem 504 in the downlink and to receive digital signals for reception from the antenna connection subsystem 504 in the uplink.

In some examples, the RU digital circuits 502 are configured to comply with one or more O-RAN standards and include an O-RAN compliant interface. In other examples, the RU digital circuits 502 use a proprietary interface.

In some examples, each RU digital circuit 502 is communicatively coupled (“homed”) to a dedicated, corresponding DU, where each DU implements a distinct cell having a different Physical Cell Identifier (PCI). In other examples, each RU digital circuit 502 is communicatively coupled (“homed”) to the same DU and thus part of the same cell with a single PCI. In other examples, one or more of the RU digital circuits 502 are communicatively coupled to a dedicated, corresponding DU and at least two of the RU digital circuits 502 are communicatively coupled to the same DU.

While the RU digital circuits 502 can be implemented as physically distinct components, it should be understood that the RU digital circuits 502 do not have to be physically distinct. For example, the RU digital circuits 502 could be “virtual” digital modules as part of a multi-operator, multi-carrier remote unit.

The antenna connection subsystem 504 is communicatively coupled to the antenna section radio circuits 506 and the antenna segments 508. Each respective antenna section radio circuit 506 is dedicated to a respective antenna segment 508.

The antenna connection subsystem 504 is configured to connect the antenna section radio circuits 506 and corresponding antenna segments 508 with different RU digital circuits 502. In some examples, the antenna connection subsystem 504 is configured to connect each antenna section radio circuit 506 and its corresponding antenna segment 508 to one and only one RU digital circuit 502 in a communication direction, but multiple antenna section radio circuits 506 and antenna segments 508 can be connected to the same RU digital circuit 502 at one time. When multiple antenna section radio circuits 506 and their corresponding antenna segments 508 are connected to the same RU digital circuit 502, the multiple antenna section radio circuits 506 and their corresponding antenna segments 508 transmit the same signal (simulcast) in the downlink and the contribution from each of the multiple antenna segments 508 and corresponding antenna section radio circuits 506 is combined in the uplink. When multiple (for example, K) adjacent antenna segments 508 are connected to the same RU digital circuit 502, the effect is to produce a combined antenna segment 508 covering ((360*K)/N) degrees of view, where N is the total number of antenna segments 508. In the example shown in FIG. 5, each antenna segment 508 covers 30 degrees.

It should be understood that FIG. 5 is a logical depiction of the components of the radio access network 500 and different components can be combined on the same hardware. In some examples, the RU digital circuits 502 and the antenna connection subsystem 504 and/or the antenna section radio circuits 506 are combined on the same hardware. In some examples, the antenna connection subsystem 504 and the antenna section radio circuits 506 combined on the same hardware.

FIG. 6 illustrates an example antenna connection subsystem 600. In the particular example shown in FIG. 6, the antenna connection subsystem 600 supports two remote units (or RU digital circuits) and six antenna segments. It should be understood that the particular configuration shown in FIG. 6 is only one example and a different number of remote units or RU digital circuits (more than two) and/or a different number of antenna segments (two or more) and, if applicable, their corresponding antenna section radio circuits (two or more) can be used.

The antenna connection subsystem 600 is divided into two stages. The first stage includes Tx simulcast/Rx combiner units 602. In the example shown in FIG. 6, each Tx simulcast/Rx combiner unit 602 includes a first port 606 configured to be communicatively coupled to a respective remote unit (or RU digital circuit) and a plurality of second ports 610 configured to be communicatively coupled to the second stage of the antenna connection subsystem 600. The Tx simulcast/Rx combiner units 602 are configured to receive transmission signals in the downlink from the respective remote unit (or RU digital circuit) and to transmit receive signals in the uplink to the respective remote unit (or RU digital circuit). The Tx simulcast/Rx combiner unit 602 is configured to transmit the same (simulcast) transmission signals to the plurality of second ports 610 in the downlink and to combine signals from the plurality of second ports 610 in the uplink. The number of second ports 610 corresponds to the maximum number of antenna segments (and corresponding antenna section radio circuits, if applicable) that any remote unit (or RU digital circuit) would be connected, which can be less than or equal to the total number of antenna segments 608.

The second stage of the antenna connection subsystem 600 includes an interconnection device 604 with a plurality of ports 612 configured to be communicatively coupled to the antenna segments (and corresponding antenna section radio circuits, if applicable). The number of ports 612 corresponds to the number of antenna elements. The interconnection device 604 is configured to connect the plurality of second ports 610 of the Tx simulcast/Rx combiner units to antenna segments (and corresponding antenna section radio circuits, if applicable). Since an antenna segment (and corresponding antenna section radio circuits, if applicable) can only be communicatively coupled to a single remote unit (or RU digital circuit) in a particular communication direction, the interconnection device 604 is configured to couple a respective antenna segment (and corresponding antenna section radio circuits, if applicable) to a single, respective remote unit (or RU digital circuit) at a time for a particular communication direction.

The antenna connection subsystem 600 is programmable or reconfigurable such that the configuration of the system can be changed depending on the needs of the deployment. In some such examples, the interconnection device 604 includes reconfigurable switches that selectively connect the plurality of second ports 610 of the Tx simulcast/Rx combiner units 602 to antenna segments (and corresponding antenna section radio circuits, if applicable) via the ports 612. In some examples, the interconnection device 604 is implemented as programmable logic (for example, in a field programmable gate array (FPGA) or System on Chip (SoC)) to communicatively couple the plurality of second ports 610 to of the Tx simulcast/Rx combiner units 602 to antenna segments (and corresponding antenna section radio circuits, if applicable) via the ports 612. In some examples, the configuration of the interconnection device 604 is reconfigured based on control signals or scheduling information from the central controller. The frequency of changes to the antenna connection subsystem 600 can occur based on the needs of the deployment and can occur as often as every transmission slot interval, if desired.

It should be noted that the connections made using the antenna connection subsystem 600 for transmissions in the downlink direction can be different than the connections made using the antenna connection subsystem 600 for reception in the uplink direction. This would be done, for example, to achieve different coverages of the segments for the downlink and uplink directions.

The examples described above with respect to FIG. 5 can have some advantages compared to the examples described above with respect to FIG. 4. First, since the RU digital circuits 502 output digital signals in the downlink to the antenna connection subsystem 504, the examples in FIG. 5 avoid the issues with analog insertion loss and passive intermodulation distortion in the antenna connection subsystem 504. Further, the examples described above with respect to FIG. 5 may be more amenable to efficient precoding implementations by, for example, replacing the Tx Simulcast stage referred to in FIG. 6 with a stage that incorporates precoding.

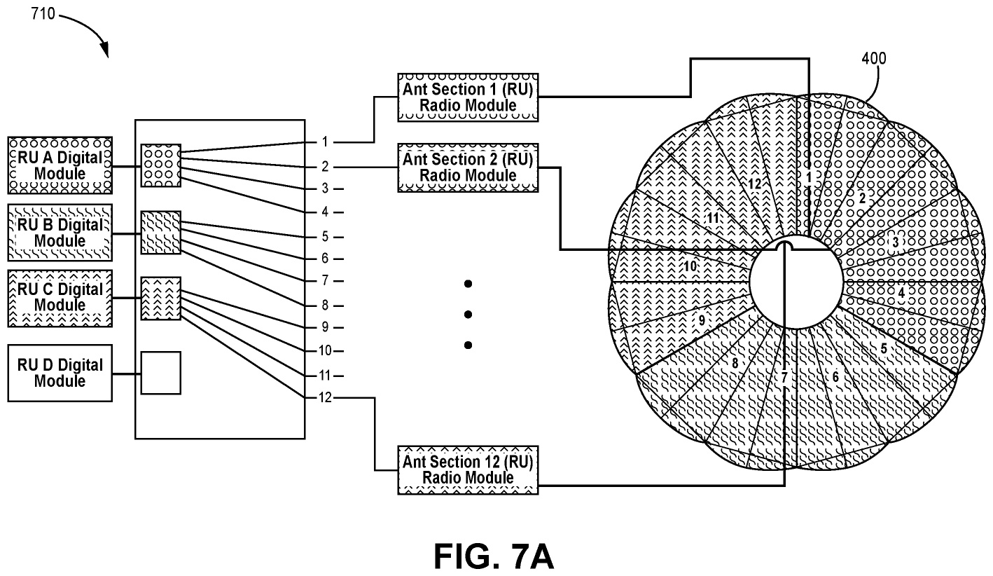

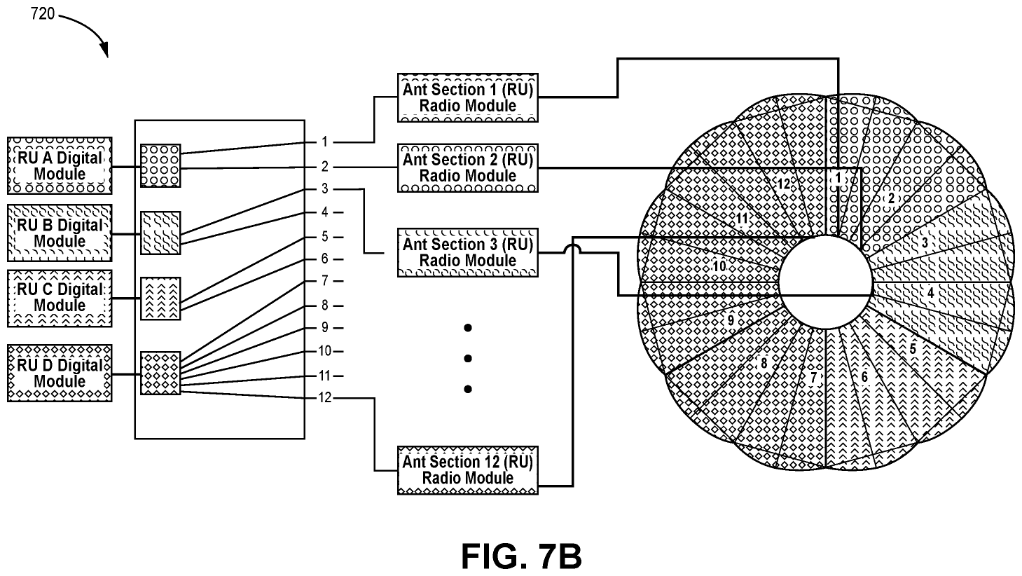

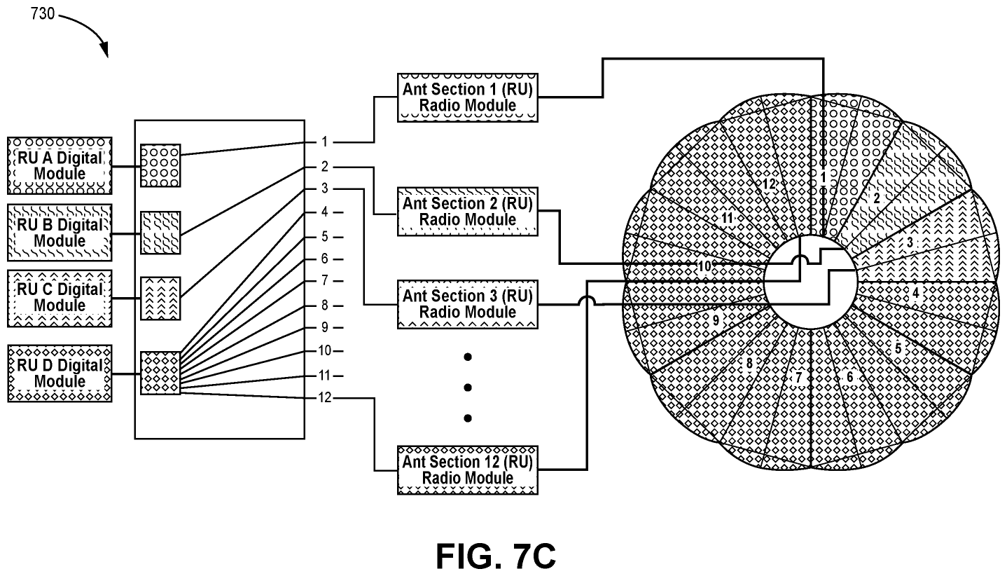

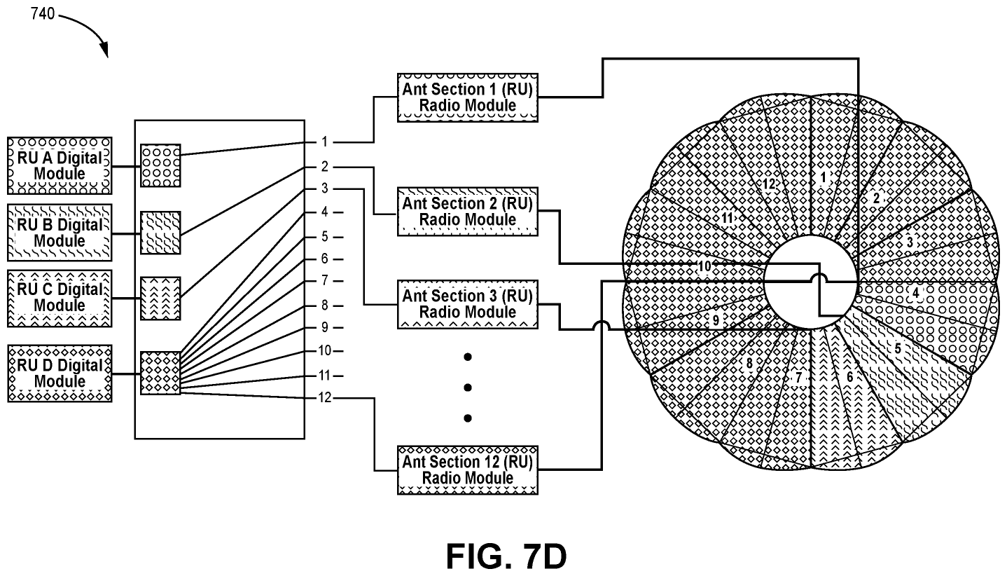

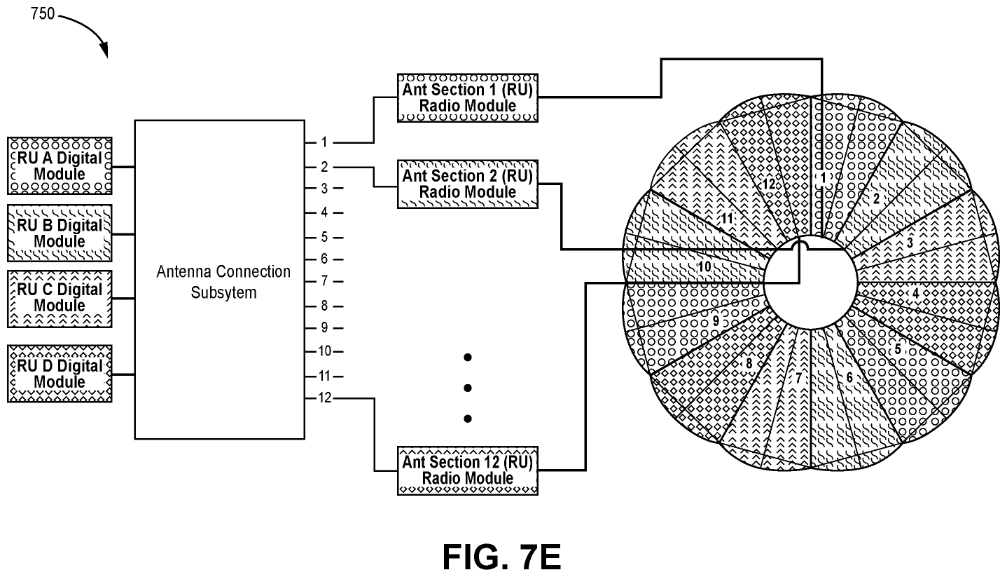

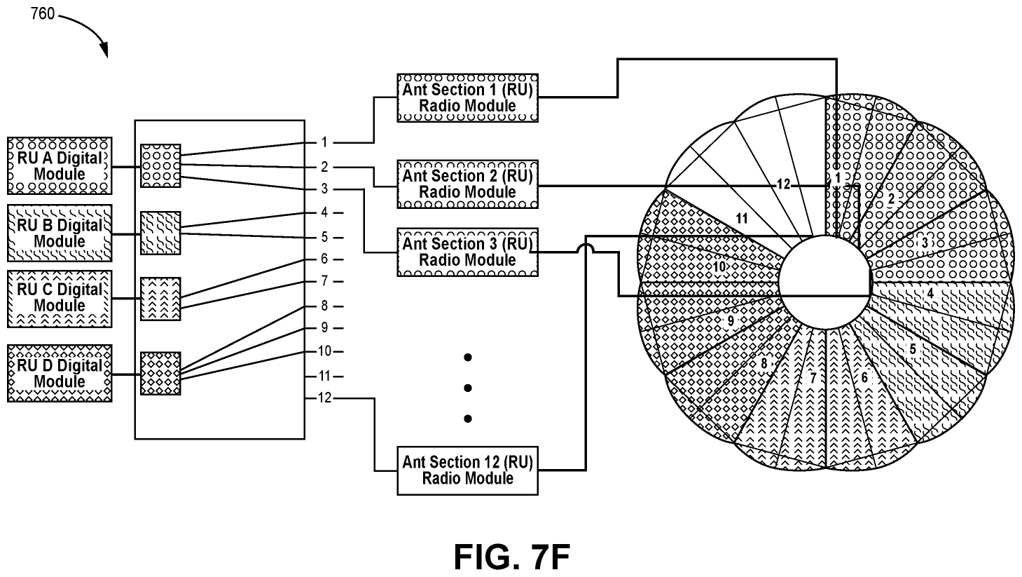

FIGS. 7A-7F illustrate example antenna configurations of the system described above with respect to FIG. 5. It should be understood that these examples are not exhaustive and other configurations are possible using the techniques described herein. Further, it should be understood that similar antenna configurations can be implemented using the system described above with respect to FIG. 4.

FIG. 7A illustrates an example antenna configuration 710 with three equal sized sectors. In the example shown in FIG. 7A, three RU digital circuits are each communicatively coupled to four antenna section radio circuits and their corresponding antenna segments using the antenna connection subsystem. In the example shown in FIG. 7A, one of the RU digital circuits (RU D Digital Module) is not connected to any antenna segments. Each of the sectors shown in FIG. 7A covers approximately 120 degrees of view.

FIG. 7B illustrates an example antenna configuration 720 with three narrow sectors and one wide sector. In the example shown in FIG. 7B, three RU digital circuits are each communicatively coupled to two antenna section radio circuits and their corresponding antenna segments using the antenna connection subsystem. Each of these sectors shown in FIG. 7B covers approximately 60 degrees of view. In the example shown in FIG. 7B, one of the RU digital circuits is communicatively coupled to six antenna segments. This sector shown in FIG. 7B covers approximately 180 degrees of view.

FIG. 7C illustrates another example antenna configuration 730 with three narrow sectors and one wide sector. In the example shown in FIG. 7C, three RU digital circuits are each communicatively coupled to a single antenna section radio circuit and its corresponding antenna segment using the antenna connection subsystem. Each of these sectors shown in FIG. 7C covers approximately 30 degrees of view. In the example shown in FIG. 7C, one of the RU digital circuits is communicatively coupled to nine antenna segments. This sector shown in FIG. 7C covers approximately 270 degrees of view.

FIG. 7D illustrates an antenna configuration 740 that is an orientation change of the example antenna configuration 730 shown in FIG. 7C. The RU digital circuits in FIG. 7D are each communicatively coupled to the same number of antenna segments as shown in FIG. 7C. However, the particular subset of antenna segments communicatively coupled to each RU digital circuit is changed such that the sectors cover different views compared to the antenna configuration in FIG. 7C.

FIG. 7E illustrates an example antenna configuration 750 with interleaved sectors. In the example shown in FIG. 7E, each RU digital circuit is communicatively coupled to three antenna section radio circuits and their corresponding antenna segments using the antenna connection subsystem. However, unlike FIGS. 7A-7D, the sectors in FIG. 7E are non-contiguous such that the adjacent antenna segments and their corresponding antenna section radio circuits are communicatively coupled to different RU digital circuits. Each of the antenna segments shown in FIG. 7E cover approximately 30 degrees of view, so each sector covers approximately 90 degrees total of view.

FIG. 7F illustrates an example antenna configuration 760 with four sectors and where some of the antenna segments are not utilized. In the example shown in FIG. 7F, two RU digital circuits are each communicatively coupled to three antenna section radio circuits and their corresponding antenna segments using the antenna connection subsystem. In the example shown in FIG. 7F, the other two RU digital circuits are each communicatively coupled to two antenna section radio circuits and their corresponding antenna segments using the antenna connection subsystem. In the example shown in FIG. 7F, two of the antenna segments are not communicatively coupled to an RU digital circuit, so these antenna segments are not utilized to transmit or receive signals with user equipment in this configuration.

In some examples, the systems shown in and described above with respect to FIGS. 4-7F are configured to support frequency reuse for transmission to UEs. “Downlink frequency reuse” refers to situations where separate downlink user data intended for different UEs is simultaneously wirelessly transmitted to the UEs using the same physical resource blocks (PRBs) for the same cell. “Uplink frequency reuse” refers to situations where separate uplink user data from different UEs is simultaneously wirelessly transmitted from the UEs using the same physical resource blocks (PRBs) for the same cell. Such reuse UEs are also referred to here as being “in reuse” with each other.

Typically, frequency reuse is implemented where the UEs in reuse are sufficiently physically separated from each other so that the co-channel interference resulting from the different wireless transmissions is sufficiently low (that is, where there is sufficient RF isolation). However, the simultaneous service can result in mutual “reuse” interference among the UEs in reuse with each other, which degrades a UE's signal-to-interference-plus-noise ratio (SINR) and data rates compared to values achievable were the PRBs the UE was allocated not used for the other UEs. The reuse interference in a particular sector is the consequence of significant gains for the antenna patterns of the other sectors in the azimuth/elevation region covered by the particular sector (referred to as “leakage” among the sectors). The leakage among the sectors limits the capacity gain achievable with reuse among the sectors in the system.

### Reuse Beamforming

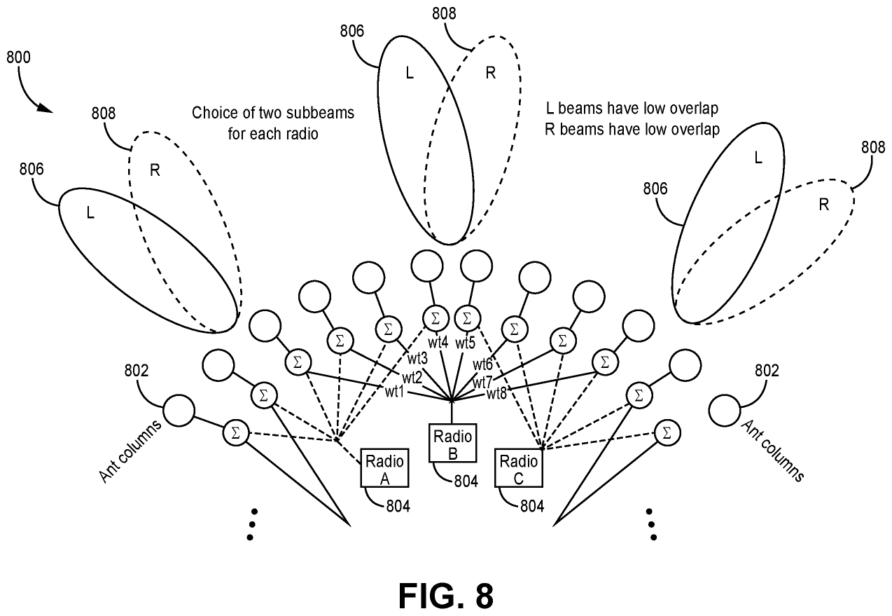

FIG. 8 illustrates an example system 800 that utilizes beamforming techniques to implement downlink and/or uplink frequency reuse. The example system in FIG. 8 includes radios 804 communicatively coupled to antenna columns 802. In the example shown in FIG. 8, each sector includes four antenna columns 802 communicatively coupled to one or more radios 804. However, it should be understood that the particular configuration shown in FIG. 8 is only one example and a different number of radios (for example, one or more), a different number of antenna columns (for example, two or more), and/or a different configuration of the radios and antenna columns (for example, the number of antenna columns coupled to each radio) can be used.

A scheduler for the system (for example, a central controller coupled to the radios (not shown in FIG. 8)) is configured to localize each UE in a particular sector. In some examples, the location for each UE is approximated by the central controller using a “signature vector” (SV) associated with that UE. In some examples, the UE location can be inferred based on received power measurements and known tapers applied to each of the antenna columns 802.

When a UE makes initial uplink transmissions (for example, Physical Random Access Channel (PRACH) transmissions), each antenna column 802 and corresponding radio 804 will receive those initial uplink transmissions and a signal reception metric indicative of the power level of the uplink transmissions received by that antenna column 802 and corresponding radio 804 is measured (or otherwise determined). One example of such a signal reception metric is SINR. The signal reception metrics that are determined based on the PRACH transmissions are also referred to here as “PRACH metrics.”

Each signature vector is determined and updated over the course of that UE's connection to the cell based on Sounding Reference Signals (SRS) transmitted by the UE. A signal reception metric indicative of the power level of the SRS transmissions received by the antenna columns 802 and correspond radios 804 (for example, SINR) is measured (or otherwise determined). The signal reception metrics that are determined based on the SRS transmissions are also referred to here as “SRS metrics.”

Each signature vector can be a set of floating point SINR values (or other metric), with each value or element corresponding to an antenna column 802 and corresponding radio 804 used to serve the cell.

In addition to, or instead of, modifying the configuration of the antenna segments included in each sector as described above with respect to FIGS. 4-7F, the system shown in FIG. 8 is configured to employ two or more antenna beam states in each sector, and apply a complex-valued tapered weighting vector (also referred to herein as a “taper”) for the beams to reduce reuse interference. The taper used for a UE within a given sector may span additional antenna segments beyond the segments nominally associated with that given sector. In some examples, in addition to using two or more antenna beam states in each sector, the system shown in FIG. 8 also utilizes coordination of the scheduling of UEs and switching between beam states among the sectors of the system.

In some such examples, the scheduler is configured to determine whether a UE is positioned on the right side or left side of the particular sector using the signature vector. In the example shown in FIG. 8, the “L” beam 806 is used to service the left side of a sector and the “R” beam 808 is used to service the right side of the sector. Thus, in the example shown in FIG. 8, the scheduler is configured to transmit signals to a UE on the left side of the sector using the “L” beam 806 and to transmit signals to a UE on the right side of the sector using the “R” beam 808. While the system of FIG. 8 is described with an example where the sector is divided into two portions (left side and right side), it should be understood that this is for ease of description and other divisions of the sector (for example, dividing the sectors into three portions) and a corresponding number of beam states (for example, three beam states) can be used.

The system 800 in FIG. 8 is configured to use multiple antenna columns 802 for a combined transmission to the UEs using a taper to reduce the leakage or sidelobes of the antenna pattern in the neighboring sectors, which reduces the associated reuse interference experienced in the sectors of the system 800. Leakage reduction is generally obtained at the cost of reduced in-sector antenna gain at the center of the sector. With any single taper design and with reuse in sectors, the signal-to-interference ratio (SIR) for UE locations near the sector borders will be limited to 0 dB for downlink transmissions. Further, uplink transmissions from in-sector UEs near borders will be received with reduced gain compared to UEs near the sector center, and with gain comparable to that for interference received from UEs near the borders but in the adjacent sectors. Such interference is particularly problematic for UEs distant from the base station and may reduce the effective base station coverage area.

The scheduler is configured to select the UEs for communication during a particular transmission time interval (TTI) based on their location. As discussed above, in some examples, the scheduler is configured to service UEs in different sectors on the same frequency resource simultaneously. When the scheduler selects a UE from the left side of a first sector for transmission using frequency resources in a particular TTI, the scheduler is configured to not select a UE from the right side of that first sector for transmission using the same frequency resources in the same TTI. In some such examples, the scheduler is also configured to not select a UE from the right side of a second sector adjacent to the left side of the first sector for transmission using the same frequency resources in the same TTI. Similarly, when the scheduler selects a UE from the right side of a first sector for transmission using frequency resources in a particular TTI, the scheduler is configured to not select a UE from the left side of that first sector for transmission using the same frequency resources in the same TTI. In some such examples, the scheduler is also configured to not select a UE from the left side of another sector adjacent to the right side of the first sector for transmission using the same frequency resources in the same TTI.

In order to provide full coverage of the cell, the scheduler is configured to switch beams used in the sectors for different TTIs. For example, the schedular can be configured to use the “L” beams 806 in even TTIs and the “R” beams 808 in odd TTIs. If the scheduler switches which beam (“L” or “R” beam) is used in a particular sector for a different TTI, the scheduler is configured to also switch the beams used in the adjacent sectors where the base station is communicating with a UE using the same frequency resources. For example, if the scheduler switches from using the “L” beam 806 to using the “R” beam 808 in a first sector, then the scheduler is configured to switch from using the “L” beam 806 to using the “R” beam 808 in the sectors adjacent to the first sector. In some examples, the scheduler uses different “duty” cycles between scheduling the “L” beam and the “R” beam based upon the traffic demands of the UEs in their respective coverage areas.

By coordinating the beam selection in this manner, the scheduler effectively creates regions in the azimuth/elevation region of a beam antenna pattern for which any gain is acceptable because UEs in those regions are not scheduled during TTIs that the given beam is used. These regions provide a buffer and the taper can be optimized to simultaneously provide high gain in the desired region of the sectors and low gain for all regions in which reuse interference for other UEs is generated (for example, maximize the ratio of the antenna pattern gain in the corresponding half-sector azimuth/elevation region, divided by the pattern gain for azimuth/elevation regions in which interference is generated when transmitting or receiving using the beam).

In some examples, the taper is optimized to reduce the leakage or sidelobes of the antenna pattern in the corresponding sides of adjacent sectors or sectors a distance away (for example, determined based on performance requirements) by allowing for significant overlap/leakage with the two immediately adjacent beams. For example, the “L” beam 806 for a first sector can be optimized to provide high gain in the left side of the first sector and to provide low gain for the left sides of both adjacent sectors by allowing for significant overlap/leakage with the “R” beam 808 in the first sector and with the “R” beam 808 in the sector to the left of the first sector. This type of taper is also referred to herein as a “capacity taper,” and it is designed for low side lobes/interference and high capacity for UEs at near to moderate distance from the base station.

In some examples, the taper for the “L” beams 806 and the “R” beams 808 shown in FIG. 8 is static. That is, the taper for the “L” beams 806 and the “R” beams 808 does not change from TTI to TTI. However, in other examples, the taper for the “L” beams 806 and the “R” beams 808 shown in FIG. 8 is dynamic and can change from TTI to TTI. In some such examples, the tapers are recomputed each TTI based on the channel responses for the particular UEs to be put in reuse. This approach can improve performance compared to using fixed tapers because the fixed tapers are optimized to minimize interference over many UE locations rather than the specific UE locations of interest for specific UEs in reuse.

### Reuse Beamforming While Balancing Coverage and Capacity

In order to obtain low sidelobes for a beam and increase capacity through frequency reuse as described above, there is generally some sacrifice in bore-sight gain/Effective Isotropic Radiated Power (EIRP) for the beam pattern. Also, when a relatively large number of UEs are in reuse, the transmit power per UE is relatively low. These two issues result in a reduced cell coverage area to achieve the aforementioned increased capacity. In many applications it is important to maximize the cell coverage area to minimize deployment cost.

In some examples, to provide the greatest coverage for a single UE, the scheduler is configured to transmit peak power on each column to that UE only (for the frequency resource allocated to the UE). In some examples, the scheduler is configured to apply a taper for this single UE that spans all antenna columns, with peak magnitude at each column, and with each column phase matching the conjugate-phase response between the column and the UE's position. This type of taper is referred to herein as a “reach taper,” and it is designed for high EIRP for UEs at greater distances from the base station. When using this reach taper for a particular UE, no other UEs can be put in reuse for the frequency resource allocated to that particular UE if all of the antenna columns are used to transmit the signals to that particular UE.

The column contribution to beam gain and EIRP descends as the azimuth angle between the column and UE position increases. Therefore, columns at relatively great azimuth angle from a UE can be removed from that UE's taper with relatively little reduction in beam gain, and these columns can be reclaimed to put other UEs in reuse. Furthermore, it is possible to overlap the tapers for different UEs at a given column for enhanced performance, subject to the peak power constraint at the column.

Reach tapers have relatively high sidelobes and interference, which generally is not an issue when multiple UEs at great distance are put in reuse each using a reach taper, as the throughput for distant UEs tends to be noise limited rather than interference limited. However, it is disadvantageous for a UE at near to moderate distance using a capacity taper to be put in reuse with a UE using a reach taper because the interference generated by the reach taper will degrade the performance for the near-moderate distant UE.

In some examples, the scheduler is configured to classify UEs using an approximate distance between each UE in a particular sector and the antenna columns of the sector in order to determine whether the UE would be better served using a capacity taper or a reach taper. In some such examples, the scheduler is configured to determine the approximate distance between each UE in a particular sector and the antenna columns of the sector based on PRACH signals, SRS signals, and/or a signature vector as described above. In some examples, the scheduler is configured to compare the approximate distance between a respective UE and the antenna columns to a distance threshold to determine whether the respective UE is a near to moderate distance from the base station (should be served using a capacity taper) or a greater distance from the base station (should be served using a reach taper). In some examples, the distance threshold is determined using a number of factors such as, for example, the antenna array gains, height of the antennas, and the like.

To address potential interference concerns when using both capacity and reach tapers in the same system, signals transmitted to UEs at near to moderate distance are orthogonally multiplexed with signals transmitted to distant UEs. In some examples, the scheduler is configured to use frequency division multiplexing (FDM) where different frequency resources allocated to the two UE classes. In other examples, the scheduler is configured to use time division multiplexing (TDM) with the two UE classes scheduled in different TTIs. In some examples, the scheduler is configured to use a combination of FDM and TDM. The “duty factors” for the two UE classes can be adjusted to match the populations and demands for the two classes and the relative importance of coverage and capacity in the deployment. In some examples, the “duty factors” are adjusted dynamically.

The techniques described above can be applied for the downlink transmissions and/or uplink receptions for the systems, and the technique improves both base station capacity and coverage. By using the antenna connection subsystem in combination with the remote units and antenna elements as described above, the systems can implement better capacity distribution based on the needs of the network, easier installation of the antenna elements since precise alignment is not needed, and easier reconfiguration after commissioning. By using the beamforming techniques described above, the systems include improved base station capacity and/or coverage based on the needs of the network, reduce/mitigate interference, and enable frequency reuse in a single PCI.

### Alternative Mounting Configuration

In some examples, rather than using mast or pole mounted antenna segments in a circular pattern or wall mounted antenna segments in a partial circular pattern, a system can include an alternative mounting configuration. For example, a system can utilize a strand-mount configuration or another configuration where the antenna columns are arranged in a differently shaped array (for example, a rectangle).

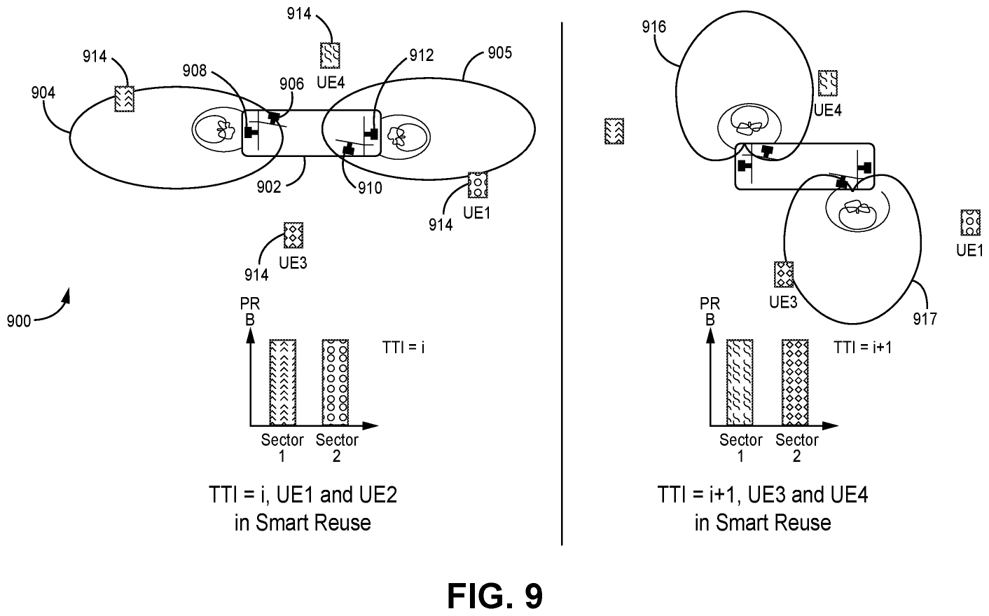

FIG. 9 illustrates an example alternative mounting configuration for a system 900 that includes a rectangular shaped housing 902 and four antenna columns 906, 908, 910, 912. In the example shown in FIG. 9, two of the antenna columns 906, 908 that point in approximately perpendicular directions are positioned on the left side of the housing 902, and the other two antenna columns 910, 912 that point in opposite directions from the first two antenna columns 906, 908 are positioned on the right side of the housing 902. In the example shown in FIG. 9, each antenna column 906, 908, 910, 912 individually has a beamwidth of approximately 90 degrees of coverage.

While not shown in FIG. 9, the antenna columns 906, 908, 910, 912 are communicatively coupled to one or more remote units (or antenna section radio circuits), which are communicatively coupled to one or more central controllers. In some examples, the system in FIG. 9 also includes an antenna connection subsystem as described above with respect to FIGS. 4-7F.

In some examples, the system 900 includes only two port sets/RF chains for transmission/reception. In some such examples, the connections between a port set and the antenna columns 906, 908, 910, 912 are preconfigured and fixed based on the anticipated distribution of UEs around the system 900. In such examples, the system 900 includes two antenna columns per port set configuration where one port set is connected to a pair of adjacent antenna columns (for example, antenna columns 906, 908) and the other port set is connected to the other pair of adjacent antenna columns (for example, antenna columns 910, 912), which permits simultaneous transmissions in two sectors of 180 degrees for each sector. For example, UE 1 shown in FIG. 9 can be serviced using both the antenna column 910 and antenna column 912 via simulcast in the downlink and combining in the uplink. While this provides 360 degrees of coverage, the peak EIRP and reach for such examples of system 900 may not provide sufficient power levels in some circumstances.

Since there is generally high interference at the sector borders, in other examples, the scheduler (for example, the central controller) is configured to activate only two antenna columns (one per sector) for a particular TTI when implementing downlink and/or uplink frequency reuse. In such examples, the system 900 includes a single antenna column per port set configuration where one port set is connected to a single antenna column and the other port set is connected to another antenna column. In such examples, the system 900 in FIG. 9 is configured to transmit signals to a given UE 914 using a single antenna column where each of the antenna columns 906, 908, 910, 912 is used to communicate with UEs having a particular distribution. For example, in the first TTI (shown on the left side of FIG. 9), the central controller is configured to activate the antenna columns 906, 908 for communicating with UEs where the distribution of UEs is predominantly east and west, and, in the next TTI, the central controller is configured to activate the antenna columns 910, 912 to communicate with different UEs where the distribution of UEs is predominantly north and south. In some such examples, the central controller is configured to activate the particular antenna columns that point in opposite directions. In this way, the central controller can utilize downlink and/or uplink frequency reuse in the opposing sectors since there is little to no reuse interference in the opposing sectors.

It should be understood that the specific orientation of the antenna columns 906, 908, 910, 912 shown in FIG. 9 is an example and other configurations are possible. For example, each of the antenna columns 906, 908, 910, 912 can be adjusted to face in different directions (such as, for example, NW, SW, NE, SE).

In some examples, the housing 902 can include additional antenna columns (not shown) that are each oriented in approximately the same horizontal direction as a particular antenna column 906, 908, 910, 912 shown in FIG. 9 and cross-polarized with that particular antenna column 906, 908, 910, 912 shown in FIG. 9. In some other examples, each of the antenna columns 906, 908, 910, 912 shown in FIG. 9 include cross-polarized antenna elements inside that are oriented in approximately the same horizontal direction as each other. The cross-polarized antenna columns or internal cross-polarized antenna elements oriented in approximately the same horizontal direction are referred to as an “antenna element set” below. In such examples, the central controller is configured to utilize the antenna element sets to transmit two streams between the antenna element set and a UE, which allows for two ports to be oriented in the same horizontal direction. It should be understood that the antenna element sets can include more than two antenna columns/elements that are oriented in approximately the same direction and have different polarizations, different vertical positions, and/or different horizontal positions. More than two antenna columns/elements can be used in order to transmit more than two streams between the antenna element set and a UE, which allows for more than two ports to be oriented in the same horizontal direction.

In some other examples, the housing 902 can include additional antenna columns (not shown) that are positioned between the antenna columns 906, 908, 910, 912 shown in FIG. 9 and oriented, for example, at +/−45 degrees azimuth compared to the antenna columns shown in FIG. 9 such that the housing 902 includes four additional antenna columns for a total of eight antenna columns. In such examples, the central controller is configured to utilize one of these intermediary antenna columns in order to transmit signals to UEs located near the edge of the sectors shown in FIG. 9 rather than combine signals from multiple antenna columns with a taper or using the antenna columns shown in FIG. 9, which would result in reduced transmission power levels or lower SINR at the UE, respectively.

By using the one antenna column per port set configuration where a single antenna column is used to transmit signals to a given UE, the system 900 shown in FIG. 9 enables greater reach in the anticipated directions for transmission to UEs compared to using two antenna columns per port set. However, in an unanticipated direction, the reach of the one antenna column per port set configuration can be less.

The system shown in FIG. 9 is configured to utilize similar techniques to those described above with respect to FIGS. 4-8 with some differences based on the alternative mounting configuration.

In some examples, the central controller is communicatively coupled to one or more remote units and the antenna connection subsystem as described above with respect to FIGS. 4-7F. In such examples, the central controller is configured to selectively couple the one or more remote units to particular antenna columns of the system depending on the needs of the system. The central controller is configured to localize the UEs in the cell and dynamically select the one or more antenna columns to use for transmitting signals to the UEs based on the location of the UEs and/or channels between the antenna columns and the UEs. In some examples, the central controller is configured to select the antenna column or antenna columns that will maximize the transmission signal power to the UE and increase the SINR at the UE. In some examples, the central controller is configured to apply a taper to transmissions from the antenna columns in a manner similar to that described above with respect to FIG. 8, which reduces interference near the boundaries of the sectors.

Other examples are implemented in other ways.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

### EXAMPLE EMBODIMENTS

Example 1 includes a system, comprising: at least one controller, wherein the at least one controller is configured to implement at least some functions for one or more layers of a wireless interface used to communicate with user equipment; one or more remote units communicatively coupled to the at least one controller; and a plurality of antenna elements communicatively coupled to the one or more remote units, wherein each respective antenna element of the plurality of antenna elements is oriented in a respective direction different than other antenna elements of the plurality of antenna elements; wherein the at least one controller is configured to: determine a location of a first user equipment in a cell of the system and/or channels between the plurality of antenna elements and the first user equipment; select one or more first antenna elements of the plurality of antenna elements for use in transmitting downlink signals to the first user equipment based on the location of the first user equipment and/or the channels between the plurality of antenna elements and the first user equipment; and transmit downlink signals to the first user equipment via the one or more first antenna elements of the plurality of antenna elements in a first time period.

Example 2 includes the system of Example 1, wherein the at least one controller is further configured to: determine a location of a second user equipment in the cell of the system and/or channels between the plurality of antenna elements and the second user equipment; select one or more second antenna elements of the plurality of antenna elements for use in transmitting downlink signals to the second user equipment in the first time period based on the location of the second user equipment and/or the channels between the plurality of antenna elements and the second user equipment, wherein the one or more second antenna elements are different than the one or more first antenna elements; and transmit downlink signals to the second user equipment via the second antenna element of the plurality of antenna elements in the first time period.

Example 3 includes the system of Example 2, wherein the at least one controller is configured to transmit downlink signals to the first user equipment and the second user equipment using the same frequency resources.

Example 4 includes the system of any of Examples 2-3, wherein the at least one controller is configured to: receive uplink signals from the first user equipment via the one or more first antenna elements of the plurality of antenna elements in a second time period; and receive uplink signals from the second user equipment via the one or more second antenna elements of the plurality of antenna elements in the second time period.

Example 5 includes the system of Example 4, wherein the at least one controller is configured to receive uplink signals from the first user equipment and the second user equipment using the same frequency resources.

Example 6 includes the system of any of Examples 1-5, wherein the at least one controller is configured to: determine a location of a second user equipment in the cell of the system and/or channels between the plurality of antenna elements and the second user equipment; select only one second antenna element of the plurality of antenna elements for use in transmitting downlink signals to the second user equipment in the first time period based on the location of the second user equipment and/or the channels between the plurality of antenna elements and the second user equipment; and transmit downlink signals to the second user equipment via the only one second antenna element of the plurality of antenna elements in the first time period.

Example 7 includes the system of any of Examples 1-6, wherein the at least one controller is configured to: select only one first antenna element of the plurality of antenna elements for use in transmitting downlink signals to the first user equipment based on the location of the first user equipment and/or the channels between the plurality of antenna elements and the first user equipment; and transmit downlink signals to the first user equipment via the only one first antenna element of the plurality of antenna elements in the first time period.

Example 8 includes the system of any of Examples 1-7, wherein each antenna element of the plurality of antenna elements is oriented in a different horizontal direction separated by approximately 90 degrees compared to another antenna element of the plurality of antenna elements; the system further comprising additional antenna elements communicatively coupled to the one or more remote units, wherein each respective additional antenna element is oriented in approximately a same horizontal direction and grouped in a respective antenna element set with a respective antenna element of the plurality of antenna elements, wherein the respective additional antenna element and the respective antenna element of the plurality of antenna elements grouped in the respective antenna element set have different polarizations, different vertical positions, and/or different horizontal positions.

Example 9 includes a system, comprising: at least one controller, wherein the at least one controller is configured to implement at least some functions for one or more layers of a wireless interface used to communicate with user equipment; a plurality of remote unit digital circuits communicatively coupled to the at least one controller; a plurality of antenna elements communicatively coupled to the plurality of remote unit digital circuits and configured to radiate radio frequency signals to the user equipment; and an antenna connection subsystem configured to selectively, communicatively couple the plurality of remote unit digital circuits to the plurality of antenna elements, wherein each of the antenna elements is configured to be coupled to a remote unit digital circuit of the plurality of remote unit digital circuits via the antenna connection subsystem for a particular communication direction.

Example 10 includes the system of Example 9, wherein the antenna connection subsystem includes simulcast/combiner units communicatively coupled to the plurality of remote unit digital circuits, wherein the antenna connection subsystem includes an interconnection device configured to selectively couple the simulcast/combiner units to the plurality of antenna elements.

Example 11 includes the system of Example 10, wherein the interconnection device includes a plurality of reconfigurable switches configured to selectively couple outputs of the simulcast/combiner units to a plurality of outputs of the interconnection device, wherein each output of the plurality of outputs is communicatively coupled to a respective antenna element.

Example 12 includes the system of any of Examples 10-11, wherein the interconnection device is implemented as programmable logic.

Example 13 includes the system of any of Examples 9-12, wherein each remote unit digital circuit of the plurality of remote unit digital circuits is coupled to a respective remote unit radio circuit in a respective remote unit, wherein the respective remote unit is configured to output respective analog downlink signals to the antenna connection subsystem in a downlink direction and to receive respective analog uplink signals from the antenna connection subsystem in an uplink direction, wherein the antenna connection subsystem is configured to output downlink analog signals to the plurality of antenna elements.

Example 14 includes the system of any of Examples 9-13, wherein each remote unit digital circuit of the plurality of remote unit digital circuits is configured to output respective digital downlink signals to the antenna connection subsystem in a downlink direction and to receive respective digital uplink signals from the antenna connection subsystem in an uplink direction, wherein the antenna connection subsystem is configured to output downlink digital signals to a plurality of remote unit radio circuits in the downlink direction, wherein each remote unit radio circuit is associated with a respective antenna element of the plurality of antenna elements.

Example 15 includes the system of any of Examples 9-14, wherein multiple antenna elements of the plurality of antenna elements are communicatively coupled to a first remote unit digital circuit of the plurality of remote unit digital circuits.

Example 16 includes the system of any of Examples 9-15, wherein at least one remote unit digital circuit of the plurality of remote unit digital circuits is communicatively coupled to a single antenna element.

Example 17 includes the system of any of Examples 9-16, wherein the plurality of antenna elements is deployed together on a tower, mast, or wall.

Example 18 includes the system of any of Examples 9-17, wherein the antenna connection subsystem is configured to selectively, communicatively couple the plurality of remote unit digital circuits to the plurality of antenna elements based on control signals or scheduling information from the at least one controller.

Example 19 includes the system of any of Examples 9-18, wherein the at least one controller is configured to reconfigure the antenna connection subsystem on a transmission time interval by transmission time interval basis.

Example 20 includes the system of any of Examples 9-19, wherein each of the antenna elements is coupled to one or fewer remote unit digital circuits of the plurality of remote unit digital circuits via the antenna connection subsystem for a particular communication direction.

Example 21 includes a system, comprising: at least one controller, wherein the at least one controller is configured to implement at least some functions for one or more layers of a wireless interface used to communicate with user equipment; one or more radio units communicatively coupled to the at least one controller; and a plurality of antenna elements communicatively coupled to the one or more radio units; wherein the at least one controller is configured to: determine a location of a first user equipment in a first sector of the system; select a first antenna beam state of a plurality of antenna beam states for the first sector to use in transmitting downlink signals to the first user equipment based on the location of the first user equipment, wherein each respective antenna beam state of the plurality of antenna beam states for the first sector includes a respective complex-valued tapered weighting vector to reduce leakage in other sectors adjacent to the first sector; and transmit downlink signals to the first user equipment using the first antenna beam state of the plurality of antenna beam states for the first sector during a first time period.

Example 22 includes the system of Example 21, wherein the first antenna beam state of the plurality of antenna beam states for the first sector includes a first complex-valued tapered weighting vector, wherein the at least one controller is configured to adjust the first complex-valued tapered weighting vector for time period different than the first time period.

Example 23 includes the system of any of Examples 21-22, wherein the at least one controller is configured to determine the location of the first user equipment based on signal reception metrics.

Example 24 includes the system of any of Examples 21-23, wherein the at least one controller is further configured to: determine a location of a second user equipment in the first sector of the system; select a second antenna beam state of the plurality of antenna beam states for the first sector to use in transmitting downlink signals to the second user equipment based on the location of the second user equipment; switch from the first antenna beam state of the plurality of antenna beam states for the first sector to the second antenna beam state of the plurality of antenna beam states for the first sector during a second time period that follows the first time period; and transmit downlink signals to the second user equipment using the second antenna beam state of the plurality of antenna beam states for the first sector during the second time period.

Example 25 includes the system of Example 24, wherein the first antenna beam state of the plurality of antenna beams states for the first sector is used to serve user equipment positioned in a first zone of the first sector, wherein the second antenna beam state of the plurality of antenna beam states for the first sector is used to serve user equipment positioned in a second zone of the first sector that is different than the first zone.

Example 26 includes the system of Example 25, wherein the first antenna beam state of the plurality of antenna beam states for the first sector includes a first complex-valued tapered weighting vector that allows leakage in the second zone of the first sector, wherein the second antenna beam state of the plurality of antenna beam states for the first sector includes a second complex-valued tapered weighting vector that allows leakage in the first zone of the first sector.

Example 27 includes the system of any of Examples 25-26, wherein the first complex-valued tapered weighting vector that allows leakage in a second zone of a second sector that is adjacent to the first zone of the first sector, wherein the second complex-valued tapered weighting vector allows leakage in a first zone of a third sector that is adjacent to the second zone of the first sector.

Example 28 includes the system of any of Examples 21-27, wherein the at least one controller is further configured to: determine a location of a second user equipment in a second sector of the system, wherein the second sector is adjacent to the first sector; select a first antenna beam state of the plurality of antenna beam states for the second sector to use in transmitting downlink signals to the second user equipment based on the location of the second user equipment; and transmit downlink signals to the second user equipment using the first antenna beam state of the plurality of antenna beam states for the second sector during the first time period.

Example 29 includes the system of Example 28, wherein the first antenna beam state of the plurality of antenna beams states for the first sector is used to serve user equipment positioned in a first zone of the first sector, wherein the first antenna beam state of the plurality of antenna beam states for the second sector is used to serve user equipment positioned in a first zone of the second sector that is non-adjacent to the first zone of the first sector.

Example 30 includes the system of Example 29, wherein the at least one controller is further configured to synchronize switching between beam states for the first sector and the second sector.

Example 31 includes the system of any of Examples 27-30, wherein the at least one controller is configured to transmit downlink signals to the first user equipment and the second user equipment using the same frequency resources.

Example 32 includes the system of any of Examples 27-31, wherein the at least one controller is configured to: receive uplink signals from the first user equipment using the first antenna beam state of the plurality of antenna beam states for the first sector during a second time period; and receive uplink signals from the second user equipment using the first antenna beam state of the plurality of antenna beam states for the second sector during the second time period.

Example 33 includes the system of Example 32, wherein the at least one controller is configured to receive uplink signals from the first user equipment and the second user equipment using the same frequency resources.

Example 34 includes a system, comprising: at least one controller, wherein the at least one controller is configured to implement at least some functions for one or more layers of a wireless interface used to communicate with user equipment; one or more radio units communicatively coupled to the at least one controller; and a plurality of antenna elements communicatively coupled to the one or more radio units; wherein the at least one controller is configured to: transmit downlink signals to a first user equipment in a first zone of a first sector of the system using a first antenna beam state of a plurality of antenna beam states for the first sector during a first time period; switch from the first antenna beam state of the plurality of antenna beam states for the first sector to a second antenna beam state of the plurality of antenna beam states for the first sector during a second time period that follows the first time period; and transmit downlink signals to a second user equipment in a second zone of the first sector of the system using the second antenna beam state of the plurality of antenna beam states for the first sector during the second time period.

Example 35 includes the system of Example 34, wherein the first antenna beam state of the plurality of antenna beam states for the first sector includes a first complex-valued tapered weighting vector that allows leakage in the second zone of the first sector, wherein the second antenna beam state of the plurality of antenna beam states for the first sector includes a second complex-valued tapered weighting vector that allows leakage in the first zone of the first sector.

Example 36 includes the system of Example 35, wherein the first complex-valued tapered weighting vector allows leakage in a second zone of a second sector that is adjacent to the first zone of the first sector, wherein the second complex-valued tapered weighting vector allows leakage in a first zone of a third sector that is adjacent to the second zone of the first sector.

Example 37 includes the system of any of Examples 34-36, wherein the at least one controller is configured to: transmit downlink signals to a third user equipment in a first zone of a second sector of the system using a first antenna beam state of the plurality of antenna beam states for the second sector during the first time period, wherein the second sector is adjacent to the first sector; switch from the first antenna beam state of the plurality of antenna beam states for the second sector to a second antenna beam state of the plurality of antenna beam states for the second sector during the second time period that follows the first time period; and transmit downlink signals to a fourth user equipment in a second zone of the first sector of the system using the second antenna beam state of the plurality of antenna beam states for the second sector during the second time period.

Example 38 includes the system of Example 37, wherein the first antenna beam state of the plurality of antenna beam states for the first sector includes a respective complex-valued tapered weighting vector that allows leakage in the second zone of the first sector and the second zone of the second sector that is adjacent the first zone of the first sector, wherein the second antenna beam state of the plurality of antenna beam states for the first sector includes a respective complex-valued tapered weighting vector that allows leakage in the first zone of the first sector and a first zone of a third sector that is adjacent to the second zone of the first sector.

Example 39 includes the system of Example 38, wherein the at least one controller is configured to synchronize switching between beam states for the first sector and switching between beam states for the second sector.

Example 40 includes the system of any of Examples 37-39, wherein the at least one controller is configured to: transmit downlink signals to the first user equipment and the third user equipment using the same frequency resources; and/or transmit downlink signals to the second user equipment and the fourth user equipment using the same frequency resources.

Example 41 includes the system of any of Examples 37-40, wherein the at least one controller is configured to: receive uplink signals from the first user equipment using the first antenna beam state of the plurality of antenna beam states for the first sector during a second time period; and receive uplink signals from the third user equipment using the first antenna beam state of the plurality of antenna beam states for the second sector during the second time period.

Example 42 includes the system of Example 41, wherein the at least one controller is configured to receive uplink signals from the first user equipment and the third user equipment using the same frequency resources.

Example 43 includes the system of any of Examples 34-42, wherein the at least one controller is configured to transmit downlink signals to the first user equipment and the second user equipment using two or more antenna elements of the plurality of antenna elements.

Example 44 includes the system of any of Examples 34-43, wherein the first antenna beam state of the plurality of antenna beam states for the first sector includes a first complex-valued tapered weighting vector, wherein the at least one controller is configured to adjust the first complex-valued tapered weighting vector for time period different than the first time period.

Example 45 includes a method, comprising: transmitting downlink signals to a first user equipment in a first zone of a first sector of a system using a first antenna beam state of a plurality of antenna beam states for the first sector during a first time period, wherein the system includes at least one controller configured to implement at least some functions for one or more layers of a wireless interface used to communicate with user equipment, one or more radio units communicatively coupled to the at least one controller, and a plurality of antenna elements communicatively coupled to the one or more radio units; switching from the first antenna beam state of a plurality of antenna beam states for the first sector to a second antenna beam state of the plurality of antenna beam states for the first sector during a second time period that follows the first time period; and transmitting downlink signals to a second user equipment in a second zone of the first sector of the system using the second antenna beam state of the plurality of antenna beam states for the first sector during the second time period, wherein the second zone is different than the first zone.

Example 46 includes the method of Example 45, further comprising: transmitting downlink signals to a third user equipment in a first zone of a second sector of the system using a first antenna beam state of the plurality of antenna beam states for the second sector during the first time period, wherein the second sector is adjacent to the first sector; switching from the first antenna beam state of the plurality of antenna beam states for the second sector to a second antenna beam state of the plurality of antenna beam states for the second sector during the second time period that follows the first time period; and transmitting downlink signals to a fourth user equipment in a second zone of the second sector of the system using the second antenna beam state of the plurality of antenna beam states for the second sector during the second time period.

Example 47 includes the method of Example 46, wherein the at least one controller is configured to transmit downlink signals to the first user equipment and third user equipment using the same frequency resources in the first time period, wherein the at least one controller is configured to transmit downlink signals to the second user equipment and the fourth user equipment using the same frequency resources in the second time period.

Example 48 includes a system, comprising: at least one controller, wherein the at least one controller is configured to implement at least some functions for one or more layers of a wireless interface used to communicate with user equipment; one or more radio units communicatively coupled to the at least one controller; and a plurality of antenna elements communicatively coupled to the one or more radio units; wherein the at least one controller is configured to: classify a first user equipment as being in a first state or in a second state based on one or more first signal reception parameters; in response to classifying the first user equipment as being in the first state, transmit downlink signals to the first user equipment via a first subset of antenna elements of the plurality of antenna elements in a first time period using a first type of antenna beam; and in response to classifying the first user equipment as being in the second state, transmit downlink signals to the first user equipment via a second subset of antenna elements of the plurality of antenna elements in the first time period using a second type of antenna beam.

Example 49 includes the system of Example 48, wherein the first type of antenna beam includes a first complex-valued tapered weighting vector that uses peak power at the first subset of antenna elements of the plurality of antenna elements and matches conjugate phase response between the first subset of antenna elements of the plurality of antenna elements and the first user equipment.

Example 50 includes the system of Example 49, wherein the first subset of antenna elements of the plurality of antenna elements includes all antenna elements of the plurality of antenna elements.

Example 51 includes the system of any of Examples 48-50, wherein the second type of antenna beam includes a second complex-valued tapered weighting vector to reduce leakage in other sectors adjacent to or a determined distance away from a sector where the first user equipment is positioned.

Example 52 includes the system of Example 51, wherein the at least one controller is configured to adjust the second complex-valued tapered weighting vector for time period different than the first time period.

Example 53 includes the system of any of Examples 48-52, wherein the at least one controller is further configured to: classify a second user equipment as being in the first state or being in the second state based on one or more second signal reception parameters; in response to classifying the second user equipment as being in the first state, transmit downlink signals to the second user equipment using the first type of antenna beam; and in response to classifying the second user equipment as being in the second state, transmit downlink signals to the second user equipment using the second type of antenna beam.

Example 54 includes the system of Example 53, in response to classifying the first user equipment as being in the first state and classifying the second user equipment as being in the second state, the at least one controller is configured to: allocate first frequency resources to transmissions using the first type of antenna beam; allocate second frequency resources to transmissions using the second type of antenna beam, wherein the first frequency resources are different than the second frequency resources; and transmit downlink signals to the second user equipment in the first time period using the second type of antenna beam.

Example 55 includes the system of any of Examples 53-54, in response to classifying the first user equipment as being in the first state and classifying the second user equipment as being in the second state, the at least one controller is configured to transmit downlink signals to the second user equipment in a second time period using the second type of antenna beam, wherein the second time period is different than the first time period.

Example 56 includes the system of any of Examples 53-55, in response to classifying the first user equipment and the second user equipment as being in the first state and sectors of the first user equipment and second user equipment being sufficiently spaced apart, the at least one controller is configured to: transmit the downlink signals to the second user equipment via a third subset of antenna elements of the plurality of antenna elements in the first time period using the first type of antenna beam, wherein the first subset of antenna elements and the third subset of antenna elements are different.

Example 57 includes the system of Example 56, wherein the at least one controller is configured to transmit downlink signals to the first user equipment and the second user equipment using the same frequency resources.

Example 58 includes the system of any of Examples 48-57, wherein the at least one controller is further configured to: determine a location of a first user equipment in a sector of the system; and select the first subset of antenna elements of the plurality of antenna elements based on the location of the first user equipment in the sector of the system.

Example 59 includes the system of any of Examples 48-58, wherein the plurality of antenna elements is mounted on a pole or mast in a circular pattern.

Example 60 includes the system of any of Examples 48-59, wherein a user equipment in the first state is approximately located farther away from the plurality of antenna elements compared to a user equipment in the second state.

Example 61 includes the system of any of Examples 48-60, wherein the one or more first signal reception parameters includes one or more measured parameters of an uplink signal from the first user equipment.

Example 62 includes the system of Example 61, wherein the one or more measured parameters of the uplink signal from the first user equipment include a received signal strength.

Example 63 includes the system of any of Examples 61-62, the one or more measured parameters of the uplink signal from the first user equipment include a received signal strength of a Physical Random Access Channel (PRACH) signal and/or a Sounding Reference Signal (SRS).

Example 64 includes the system of any of Examples 48-63, wherein the one or more first signal reception parameters includes measured parameters of a downlink signal from the at least one controller.

Example 65 includes a method, comprising: classifying a first user equipment in a sector of a system as being in a first state or a second state based on one or more first signal reception parameters, wherein the system includes at least one controller configured to implement at least some functions for one or more layers of a wireless interface used to communicate with user equipment, wherein the system further includes one or more radio units communicatively coupled to the at least one controller and a plurality of antenna elements communicatively coupled to the one or more radio units; in response to classifying the first user equipment as being in the first state, transmitting downlink signals to the first user equipment via a first subset of antenna elements of the plurality of antenna elements in a first time period using a first type of antenna beam; and in response to classifying the first user equipment as being in the second state, transmitting downlink signals to the first user equipment via a second subset of antenna elements of the plurality of antenna elements in the first time period using a second type of antenna beam.

Example 66 includes the method of Example 65, wherein the first type of antenna beam includes a first complex-valued tapered weighting vector that uses peak power at the first subset of antenna elements of the plurality of antenna elements and matches conjugate phase response between the first subset of antenna elements of the plurality of antenna elements and the first user equipment.

Example 67 includes the method of Example 66, wherein the first subset of antenna elements of the plurality of antenna elements includes all antenna elements of the plurality of antenna elements.

Example 68 includes the method of any of Examples 65-67, wherein the second type of antenna beam includes a second complex-valued tapered weighting vector to reduce leakage in other sectors adjacent to or a determined distance away from a sector where the first user equipment is positioned.

Example 69 includes the method of any of Examples 65-68, further comprising: classifying a second user equipment as being in the first state or the second state based on one or more second signal reception parameters; in response to classifying the second user equipment as being in the first state, transmitting downlink signals to the second user equipment using the first type of antenna beam; and in response to classifying the second user equipment as being in the second state, transmitting downlink signals to the second user equipment using the second type of antenna beam.

Example 70 includes the method of Example 69, further comprising: in response to classifying the first user equipment as being in the first state and classifying the second user equipment as being in the second state, allocating first frequency resources to transmissions using the first type of antenna beam; allocating second frequency resources to transmissions using the second type of antenna beam, wherein the first frequency resources are different than the second frequency resources; and transmitting downlink signals to the second user equipment in the first time period using the second type of antenna beam.

Example 71 includes the method of any of Examples 69-70, further comprising: in response to classifying the first user equipment as being in the first state and classifying the second user equipment as being in the second state, transmitting downlink signals to the second user equipment in a second time period using the second type of antenna beam, wherein the second time period is different than the first time period.

Example 72 includes the method of any of Examples 69-71, further comprising: in response to classifying the first user equipment and the second user equipment as being in the first state and sectors of the first user equipment and second user equipment being sufficiently spaced apart, transmitting the downlink signals to the second user equipment via a third subset of antenna elements of the plurality of antenna elements in the first time period using the first type of antenna beam, wherein the first subset of antenna elements and the third subset of antenna elements are different.

Example 73 includes the method of Example 72, further comprising transmitting downlink signals to the first user equipment and the second user equipment using the same frequency resources.

Example 74 includes the method of any of Examples 65-73, further comprising: determining a location of a first user equipment in the sector of the system; and selecting the first subset of antenna elements of the plurality of antenna elements based on the location of the first user equipment in the sector of the system.

Example 75 includes the method of any of Examples 65-74, wherein the plurality of antenna elements is mounted on a pole or mast in a circular pattern.

Example 76 includes the method of any of Examples 65-75, wherein a user equipment in the first state is approximately located farther away from the plurality of antenna elements compared to a user equipment in the second state.

Example 77 includes the method of any of Examples 65-76, wherein the one or more first signal reception parameters includes one or more measured parameters of an uplink signal from the first user equipment.

Example 78 includes the method of Example 77, wherein the one or more measured parameters of the uplink signal from the first user equipment include a received signal strength.

Example 79 includes the method of any of Examples 77-78, wherein the one or more measured parameters of the uplink signal from the first user equipment include a received signal strength of a Physical Random Access Channel (PRACH) signal and/or a Sounding Reference Signal (SRS).

Example 80 includes the method of any of Examples 65-79, wherein the one or more first signal reception parameters includes measured parameters of a downlink signal from the at least one controller.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

1. A system, comprising:
at least one controller, wherein the at least one controller is configured to implement at least some functions for one or more layers of a wireless interface used to communicate with user equipment;
one or more remote units communicatively coupled to the at least one controller; and
a plurality of antenna elements communicatively coupled to the one or more remote units, wherein each respective antenna element of the plurality of antenna elements is oriented in a respective direction different than other antenna elements of the plurality of antenna elements;
wherein the at least one controller is configured to:
determine a location of a first user equipment in a cell of the system and/or channels between the plurality of antenna elements and the first user equipment;
select one or more first antenna elements of the plurality of antenna elements for use in transmitting downlink signals to the first user equipment based on the location of the first user equipment and/or the channels between the plurality of antenna elements and the first user equipment; and
transmit downlink signals to the first user equipment via the one or more first antenna elements of the plurality of antenna elements in a first time period.

2. The system of claim 1, wherein the at least one controller is further configured to:
determine a location of a second user equipment in the cell of the system and/or channels between the plurality of antenna elements and the second user equipment;
select one or more second antenna elements of the plurality of antenna elements for use in transmitting downlink signals to the second user equipment in the first time period based on the location of the second user equipment and/or the channels between the plurality of antenna elements and the second user equipment, wherein the one or more second antenna elements are different than the one or more first antenna elements; and
transmit downlink signals to the second user equipment via the one or more second antenna elements of the plurality of antenna elements in the first time period.

3. The system of claim 2, wherein the at least one controller is configured to transmit downlink signals to the first user equipment and the second user equipment using the same frequency resources.

4. The system of claim 2, wherein the at least one controller is configured to:
receive uplink signals from the first user equipment via the one or more first antenna elements of the plurality of antenna elements in a second time period; and
receive uplink signals from the second user equipment via the one or more second antenna elements of the plurality of antenna elements in the second time period.

5. The system of claim 4, wherein the at least one controller is configured to receive uplink signals from the first user equipment and the second user equipment using the same frequency resources.

6. The system of claim 1, wherein the at least one controller is configured to:
determine a location of a second user equipment in the cell of the system and/or channels between the plurality of antenna elements and the second user equipment;
select only one second antenna element of the plurality of antenna elements for use in transmitting downlink signals to the second user equipment in the first time period based on the location of the second user equipment and/or the channels between the plurality of antenna elements and the second user equipment; and
transmit downlink signals to the second user equipment via the only one second antenna element of the plurality of antenna elements in the first time period.

7. The system of claim 1, wherein the at least one controller is configured to:
select only one first antenna element of the plurality of antenna elements for use in transmitting downlink signals to the first user equipment based on the location of the first user equipment and/or the channels between the plurality of antenna elements and the first user equipment; and
transmit downlink signals to the first user equipment via the only one first antenna element of the plurality of antenna elements in the first time period.

8. The system of claim 1, wherein each antenna element of the plurality of antenna elements is oriented in a different horizontal direction separated by approximately 90 degrees compared to another antenna element of the plurality of antenna elements;
the system further comprising additional antenna elements communicatively coupled to the one or more remote units, wherein each respective additional antenna element is oriented in approximately a same horizontal direction and grouped in a respective antenna element set with a respective antenna element of the plurality of antenna elements, wherein the respective additional antenna element and the respective antenna element of the plurality of antenna elements grouped in the respective antenna element set have different polarizations, different vertical positions, and/or different horizontal positions.

9. A system, comprising:
at least one controller, wherein the at least one controller is configured to implement at least some functions for one or more layers of a wireless interface used to communicate with user equipment;
a plurality of remote unit digital circuits communicatively coupled to the at least one controller;
a plurality of antenna elements communicatively coupled to the plurality of remote unit digital circuits and configured to radiate radio frequency signals to the user equipment; and
an antenna connection subsystem configured to selectively, communicatively couple the plurality of remote unit digital circuits to the plurality of antenna elements, wherein each of the plurality of antenna elements is configured to be coupled to a remote unit digital circuit of the plurality of remote unit digital circuits via the antenna connection subsystem for a particular communication direction.

10. The system of claim 9, wherein the antenna connection subsystem includes simulcast/combiner units communicatively coupled to the plurality of remote unit digital circuits, wherein the antenna connection subsystem includes an interconnection device configured to selectively couple the simulcast/combiner units to the plurality of antenna elements.

11. The system of claim 10, wherein the interconnection device includes a plurality of reconfigurable switches configured to selectively couple outputs of the simulcast/combiner units to a plurality of outputs of the interconnection device, wherein each output of the plurality of outputs is communicatively coupled to a respective antenna element.

12. The system of claim 10, wherein the interconnection device is implemented as programmable logic.

13. The system of claim 9, wherein each remote unit digital circuit of the plurality of remote unit digital circuits is coupled to a respective remote unit radio circuit in a respective remote unit, wherein the respective remote unit is configured to output respective analog downlink signals to the antenna connection subsystem in a downlink direction and to receive respective analog uplink signals from the antenna connection subsystem in an uplink direction, wherein the antenna connection subsystem is configured to output downlink analog signals to the plurality of antenna elements.

14. The system of claim 9, wherein each remote unit digital circuit of the plurality of remote unit digital circuits is configured to output respective digital downlink signals to the antenna connection subsystem in a downlink direction and to receive respective digital uplink signals from the antenna connection subsystem in an uplink direction, wherein the antenna connection subsystem is configured to output downlink digital signals to a plurality of remote unit radio circuits in the downlink direction, wherein each remote unit radio circuit is associated with a respective antenna element of the plurality of antenna elements.

15. The system of claim 9, wherein multiple antenna elements of the plurality of antenna elements are communicatively coupled to a first remote unit digital circuit of the plurality of remote unit digital circuits.

16. The system of claim 9, wherein at least one remote unit digital circuit of the plurality of remote unit digital circuits is communicatively coupled to a single antenna element.

17. The system of claim 9, wherein the plurality of antenna elements is deployed together on a tower, mast, or wall.

18. The system of claim 9, wherein the antenna connection subsystem is configured to selectively, communicatively couple the plurality of remote unit digital circuits to the plurality of antenna elements based on control signals or scheduling information from the at least one controller.

19. The system of claim 9, wherein the at least one controller is configured to reconfigure the antenna connection subsystem on a transmission time interval by transmission time interval basis.

20. The system of claim 9, wherein each of the plurality of antenna elements is coupled to one or fewer remote unit digital circuits of the plurality of remote unit digital circuits via the antenna connection subsystem for a particular communication direction.

21-80. (canceled)
